(19) United States
(12) Patent Application Publication
(10) Pub. No.: US 2026/0049882 A1
(43) Pub. Date: Feb. 19, 2026

(54) INTEGRATED INTERNAL AND EXTERNAL ONLINE REAL-TIME EXTRINSIC LEAK DETECTION USING FIBER OPTIC SENSOR BASED ACOUSTIC LEAK DETECTION AND DISTRIBUTED FIBER OPTIC SENSING LEAK DETECTION

(71) Applicant: Acoustic Systems Incorporated, Houston, TX (US)

(72) Inventors: Bao-Wen YANG, Houston, TX (US); Marion RECANE, Houston, TX (US); Eric YANG, Houston, TX (US); Jeremy SILBER, Houston, TX (US); Stephanie Harn YANG, Houston, TX (US)

(21) Appl. No.: 18/952,624

(22) Filed: Nov. 19, 2024

Related U.S. Application Data
(60) Provisional application No. 63/683,706, filed on Aug. 16, 2024.
(60) Provisional application No. 63/713,826, filed on Oct. 30, 2024.

(51) Int. Cl. G01M 3/04

(52) U.S. Cl. CPC G01M 3/04

(57) ABSTRACT

A system utilizing internal and external online, real-time direct leak detection based on applying fiber optic sensors to detect leak generated acoustic waves or negative pressure wave inside the pipeline and utilizing the same fiber optic sensing cable or a different fiber optic sensing cable to detect leak outside of the pipeline. This approach encompasses two different fiber optic technologies to detect leaks both internally and externally and involves quasi-distributed and/or distributed sensing techniques. This system will detect leaks internally or intrinsically by sensing the leak generated acoustic signals propagated inside tubulars, pipes, pipelines, flow channels, or any pressurized system, as well as externally or extrinsically by detecting leak released fluid or leak event associated phenomena outside of the leaking systems respectively. These two technologies may detect leaks separately or jointly.

### CROSS-REFERENCE TO RELATED APPLICATIONS

The present application claims priority from US. Provisional Ser. No. 63/683,706 , filed on Aug. 16, 2024, presently pending. The present application also claims priority from U.S. Provisional Ser. No. 63/713,826 , filed on Oct. 30, 2024, presently pending

### FIELD OF THE INVENTION

The invention pertains to leak detection systems for tubes, pipes, pipelines, flow channels of any form and shape, or any pressurized system on an on-line real-time basis. More specifically, the present invention pertains to leak detection systems for detecting and locating leaks in tubular apparatuses or systems, including, but not limited to, enclosed flow channels, pressurized systems/containments, or transportation pipelines for water, chemicals, oil, gas, or any other types or forms of fluids, in single phase or multi-phase, onshore or offshore, inside or outside of plants, with or without flow, and above or underground.

### BACKGROUND OF THE INVENTION

Online, real-time pipeline leak detection methods generally fall into two categories: indirect (or intrinsic) and direct (or extrinsic) leak detection systems. Indirect leak detection systems apply computational pipeline monitoring through mathematical models representing fundamental laws of conservation and fluid dynamics to compare the computed values against the measured data and determine the occurrence of leak based on the deviations between them. In contrast, direct or extrinsic leak detection systems identify signals or phenomena directly created by or associated with the leak event. That is, online real-time leak detection and pipeline monitoring can be achieved by either detecting leak phenomena directly, such as acoustic signals inside or outside the pipeline or other detectable property changes on any sensing element (such as acoustic or fiber optic sensor) caused by the fluid discharge outside the pipeline, or by deriving the leak decision indirectly, or intrinsically, which involves detecting leaks based on observed deviations between the actual measured data reflecting a leak condition, and the computed values using conservation laws or other models representing relationships among different variables under a no-leak assumption. Most conservation law-based indirect (intrinsic) leak detection systems, including steady-state mass or volume balance models, real time transient modeling (RTTM), statistical approaches, pressure point analysis, or other fluid dynamics-based leak detections, often suffer from various measurement and modeling uncertainties, uncertainty due to various degrees of line packing along the pipeline, as well as slow response and location uncertainty. This challenge is especially pronounced for pipelines transporting compressible fluids, gas or two-phase flow. Thus, the indirect leak detection systems tend to be less reliable resulting in an increase in false alarms.

In theory, phenomena-based direct leak detection methods should be faster than indirect methods as they do not require long measuring times, computational times, converging times, and the time required for deviation to exceed the “leak uncertainty threshold” representing the sum of measurement and modeling uncertainties and time delay. However, in reality, this benefit of rapid response for direct leak detection is mostly true only for internal leak detection approaches, such as acoustic or negative pressure wave leak detection methods, where the process of transporting the leak generated signals is well defined and the signals are protected and guided by the pipe wall, as such the travel time required for the leak generated signals to reach sensing element is under total control, predictable with minimum uncertainty. On the other hand, in the case of external leak detection methods, such as the distributed fiber optic sensing leak detection systems, major uncertainties and delay often arise due to the delay and uncertainty of the fluid dispersion in soil to reach the sensing cable. The sensing cable is typically located only on one side of the pipeline, half a meter or more away. Therefore, the likelihood of the leak-associated phenomena propagating through the soil and reaching the sensing optical cable is uncertain and will take considerable time, especially in the cases of leaking out of the direction different from the direction of fiber optic cable. This is a very critical factor that is often overlooked by many researchers, manufacturers, and users.

With the distributed fiber optic sensing technology, as light is sent through the fiber optic cable, most of it travels straight through. However, a small portion of the light interacts with the imperfections in the fiber optic cable. Different types of interactions can cause a portion of the light to scatter in different directions with different characteristics. Different types of scattering algorithms that are sensitive to different property changes can be designed and applied to sense the changes of different properties at the point of interaction or scattering. These algorithms include, but are not limited to Raman scattering, Rayleigh Scattering, Brillouin Scattering, FBG (Fiber Bragg Gratings) scattering, and interferometric sensing.

With this type of leak detection system, due to limitations in installation, most, if not all, of the fiber optic cables are not installed inside or directly attached to the pipeline wall continuously. Instead, they are installed along the length of the pipeline in proximity as described above, and they act as a continuous, distributed sensor with intent to monitor the entire length of the pipeline in real-time basis and detect leaks by detecting any change of properties (such as changes of temperature, vibration, or strain) or any phenomena (vibration or noise) caused by the leaking event at any vicinity of the sensing cable through the external impact of the discharged fluid, with detecting span at the distance of sensing resolution.

On the other hand, acoustic (or negative pressure wave) leak detection systems work by applying sensors along or at the end of a pipeline to capture leak-generated acoustic waves that travel inside the pipeline upon the occurrence of a leak. Since leak-generated acoustic signals, with unique acoustic fingerprints, are sustained and guided by the pipe wall and propagate inside the pipeline at the speed of sound, with advanced data processing techniques, such as the acoustic fingerprint pattern recognition technique (Yang et al., U.S. Pat. No. 6,389,881), such extrinsic acoustic leak detection can provide the most reliable, sensitive, fastest, and accurate leak detection and locating performance. As such, among all the direct and indirect leak detection methods, the most reliable and accurate direct leak detection method is the acoustic leak detection approach. This is especially true when advanced data analysis technologies, including but not limited to acoustic fingerprint matching, dynamic threshold, moving window averaging, and directional filtering, are used to positively identify the unique acoustic signals generated by leaks that propagate inside and are sustained by the pipeline.

Various patents have been issued in the past relating to acoustic leak detection in pipelines. For example, U.S. Pat. No. 3,760,280 to Covington, which discloses a method and apparatus for delaying an electrical signal. The electrical signal to be delayed is converted into a frequency modulated signal which is coupled to a digital memory device that operates in response to a control signal. The rate of the control signal and the capacity of the memory device determine the delay of the FM signal. The delayed FM signal is then demodulated back to its original format.

U.S. Pat. No. 3,903,729 to Covington, discloses a method and apparatus for detecting a break or other occurrence in a pipeline containing gas under pressure. This patent discloses detecting the adiabatic pressure wave generated in the gas by the break and propagated through the gas at the speed of sound. The location of the break is determined by the change of pressure with respect to time of the leading wedge of adiabatic pressure wave. Spaced pressure-electrical transducers are utilized to detect the compressional waves. Electronic circuitry is utilized to delay a selected one of the transduced electrical signals for a selective time interval to substantially eliminate the portion of the signal responsive to compressional wave traveling in the direction opposite the preselected direction.

U.S. Pat. No. 4,455,863 to Huebler, et al., discloses the sonic detection of gas leaks in underground pipes. The patent detects sound waves created by leaking gas using a sound transducer attached to an elongated probe inserted into the ground for a substantial portion of its length. The elongated probe and transducer combination has an effective mechanical resonant frequency equal to or below the electrical resonant frequency of the sound transducer. The passive sonic detection apparatus and process of this invention provides improved sensitivity for detection of sounds created by leaking gas and thereby more accurate pinpointing of the gas leak in an underground pipeline.

U.S. Pat. No. 5,101,774 to Marziale, et al., discloses an acoustic leak detection system. The system is monitored for leaks by an acoustic leak detection system responsive to atmospherically carried sound transmissions. Energy level amplitudes of respective analog electrical signals generated sequence multiplicity of microphones are converted in a rapid time sequence to a first electric pulse signal sequence representative of corresponding digital values.

U.S. Pat. No. 5,201,212 to Williams, discloses a method and apparatus for testing underground fluid containing lines for leaks. The apparatus includes a differential pressure transducer mounted to a reservoir for indicating volumetric change in the reservoir, a temperature transducer mounted in the reservoir for monitoring temperature fluctuation in the reservoir, a gauge pressure transducer mounted in the reservoir, and a remote temperature sensor and data acquisition and processing system. Readings are taken and pressure and temperature fluctuations in the line are tested at 30 second intervals. Thereafter, the system calculates the leak rate during each 5-minute interval of the test, as well as a cumulative leak rate.

One of the present inventors is the inventor of several patents in the field. For example, U.S. Pat. No. 6,389,881 issued on May 21, 2002 to Yang, et al. describes a method and apparatus for pattern match filtering for real time acoustic pipeline leak detection and location. The patent describes how pattern match filtering is used to reduce false alarm rate, increase sensitivity and improve leak location accuracy, while quickly detecting leaks by the acoustic signal generated from a leak event in pipelines containing gas or liquid under pressure. The pattern match filtering technique detects a pressure wave generated by a leak, but discriminates against background noise and pressure disturbance generated by other non-leak sources that might otherwise be detected as a leak. The pattern match filtering derives a sharp peaked output from the signal of the expansion wave, which allows for a distinctive point of reference for a time stamp. This provides for improved accuracy in leak location calculations. The pattern match filtering is incorporated into site processors located at multiple points along a pipeline, and at a central node processor, which receives data from all site processors, performs further evaluation and identification, leak detection, leak location computation, as well as scraper position and speed calculation. The pattern match filter includes using previously recorded leak profiles. At site processors located at multiple points along a pipeline, a series of previously recorded signature profiles are continuously compared in real time against pipeline pressure signals. Data from each site processor is used collectively at a node processor and compared against multiple leak profiles to provide further false alarm rejection. The leak event data generated at each site processor is used by the node processor to declare a leak. By the application of this pattern match filter technique, the signal to noise ratio (S/N ratio) required to identify a leak event is reduced and the sensitivity of leak detection is increased. U.S. Pat. No. 6,668,619 issued to Yang et al. on Dec. 30, 2003 describes a related method of pattern match filtering.

With increasing demand for protecting existing operational pipelines, the need for non-intrusive sensor methods for leak detection has become increasingly necessary to mitigate costs and provide significantly easier installation for installing leak detecting sensors on the operating pipeline. However, the cost and difficulty of installation is a hindrance to their overall appeal for the conventional intrusive acoustic methods. The intrusive acoustic sensors require drilling to gain access to install each sensor. This is both costly, and increasingly dangerous depending on where in the pipeline or pressurized system the sensor is being installed. The cost of installing typical intrusive sensors is exacerbated by the number of hot taps and drilling requirements. Additionally, an excessive number of these access points could potentially add to the failure modes of the system. The outcome is the sensors are placed at distant intervals, which often leads to large reductions of signal strength and increased possibility of the failure of detecting smaller leaks.

The present invention addresses the problems and limitations of the previous efforts of others. It is the object of this present invention to apply two different fiber optic sensing techniques for detecting both internal (detecting acoustic signals generated by the leak event and propagation inside of the pipeline) and external leak associated phenomena (detecting any discharged fluid or associated phenomena generated from the leak and any presence outside of the pipeline) in order to reduce the installation cost of the conventional local processor based acoustic leak detection system while increasing leak detection reliability for the conventional distributed fiber optic sensing leak detection method. This invention can be applied to all industries requiring leak detection. Other industries or systems that have been intrigued by the use of leak detection systems include, but are not limited to, nuclear (i.e. heater rods, etc.), mining, power plants, culinary, food and beverage, loading docks, etc.

### SUMMARY OF THE INVENTION

For acoustic leak detection systems, one significant development was the advancement from intrusive to non-intrusive sensing in an acoustic leak detection system. It has been well established that several non-intrusive sensors (NIS) may be used in this advanced NIS acoustic leak detection system (Yang et al., U.S. Pat. No. 8,346,492). One of the disadvantages of NIS with traditional strain gage sensors is the reduction of sensitivity due to the damping effect from the mass volume of the pipe wall. However, one of the inventions in this patent is the application of fiber optic sensors as the non-intrusive sensing element of the previous patented NIS sensing system to increase the sensitivity and efficiency of non-intrusive sensing. Utilizing non-intrusive fiber optic sensors provides for a greater number of sensors which can be used because the installation process, being significantly easier, mitigates that cost and risk without the cost of sensitivity reduction. The usage of the fiber optics instead of strain gauges would also help to reduce the damping effect from the strain gauges.

While the current apparatus has several embodiments, the overall reasoning behind the technology is fundamentally the same. In traditional fiber optic-based leak detection systems one, dual, or multiple distributed fiber optic sensing cables (DFOS) are buried along the pipeline, either close to the pipeline (for most dedicated leak detection cables) or at a certain distance from the pipeline and in a certain direction of the pipeline depending on the fluid being transported (typically above the pipeline for gases lighter than air & below the pipeline for liquid or gases heavier than air). These cables can operate based on optical time domain reflectometry (OTDR) or based on optical frequency domain reflectometry (OFDR) and may be either communication fiber optic cables or dedicated leak detection fiber optic sensing cables.

Most of the parameters that fiber optics rely on in detecting leaks require direct contact of leak released fluid with the fiber optic cable, such as temperature, strain, and vibration. The chance of the released fluid contacting with the fiber optic cable is relatively small and is strongly dependent on the relative distance and direction of the leak. As such, the risk of missing a leak event is extremely high for a conventional fiber optic leak detection system. Varying soil conditions and changing water levels along the pipeline and fiber optic cable will also create potential problems.

In this invention, in order to minimize the risk of missing or not detecting leaks due to the high uncertainty involved in the above described “dispersion” of “leak fluid” and/or “leak associated event/phenomena” from the breaking point to the fiber optic cable and to reduce the false alarm caused by “noise” from the “open” environment associated with this type of external leak detection system, the above fiber optic sensing cable, or a separate designated fiber optic cable, either communication cable or dedicated distributed fiber optic sensing (DFOS) cable, can be designed and utilized to detect the leak generated acoustic wave (or negative pressure waves) traveling inside the pipeline. In one embodiment of this invention, the fiber optic cable is designed to achieve a quasi-distributed sensing function with the fiber optic sensing elements installed and sensing only at certain designed locations (instead of the entire length of the pipeline as in a distributed sensing system), depending on the strength, characteristics of the leak generated signals, system pressure, background noise, expected detectable leak size, etc. Such designated local sensing can be achieved by FBG (Fiber Bragg Grating) with specifically designed grating pattern inscribed at designed locations along the pipeline or by a combination of light source pulsation frequency and data scanning frequency control applied to a distributed sensing system to gather scattering data only for certain designed location with scattering signals arriving at certain corresponding light travel time.

That is, a quasi-distributed sensing approach, such as FBG with pre-inscribed special patterns of material interferences at pre-determined location(s), and/or a distributed sensing approach (such as, but not limited to, Rayleigh Scattering DAS (Distributed Acoustic Sensing), Brillouin Scattering (Distributed Strain Sensing (DSS/DTS or DTSS)), or other scattering techniques) are utilized to detect the leak generated acoustic wave (or negative pressure wave) that travel inside the pipeline line, transmitted through the pipe wall at certain designated locations. One embodiment of this invention is a system that uses fiber optic sensors to replace the strain gage type sensor in the previously patented non-intrusive sensing leak detection technology for detecting leak generated acoustic wave (acoustic leak detection) inside the pipeline. In this invention, such fiber optic sensor for internal acoustic leak detection system can be designed into a long fiber optic communication cable or a dedicated fiber optic cable and integrated with the conventional distributed fiber optic sensing external leak detection system to provide the benefit of both internal and external direct leak detections, reduce cost, increase reliability, improve efficiency, increase leak locating accuracy, reduce false alarm, and boost the overall system performance.

An embodiment of the present invention is a system for detecting and locating leaks in a pipeline, flow channel or pressurized fluid system. The system includes a plurality of sensors positioned at spaced intervals along said pipeline. The plurality of sensors may be intrusive or non-intrusive fiber optic or strain gauge acoustic sensors. The plurality of sensors are suitable for measuring negative or positive acoustic pressure waves, strain, vibration or other internal leak signals. The system includes a separate or combined fiber optic sensing cable installed externally to the pipeline for measurement of internal leak signals, such as leak generated acoustic pressure wave (or negative pressure wave) and external leak signals, such as temperature, strain, vibration, or acoustic changes caused by discharged fluid. The plurality of signal processors are programmed and adapted to process analyzed data gathered via the fiber optic sensors and/or strain gauge acoustic sensors. The plurality of signal processors analyze data at either each local data gathering site (such as a local or site processor) or at a central location (a central or node processor). The system preferably includes a leak computer comprising effective computing, storage, display, and other necessary functions to provide further advanced data processing, leak location calculation or verification, data and history recording, and human machine interfacing, etc.

In an embodiment, the present invention is a system including a fiber optic cable installed along the pipeline and a plurality of sensors positioned along the pipeline. A plurality of local processors are in communication with respective sensors of the plurality of sensors. The fiber optic cable adapted for communication between the plurality of local processors and a node processor.

In an embodiment, the plurality of sensors are intrusive acoustic sensors. In another embodiment, the plurality of sensors are non-intrusive strain gauge acoustic sensors. In another embodiment, the plurality of sensors are fiber optic sensors.

In an embodiment, the fiber optic cable is adapted to provide both communication between the plurality of local processors and a node processor and also distributed fiber optic sensing along the length of the fiber optic cable.

In an embodiment, the plurality of sensors are affixed to the pipeline using a strip surrounding the circumference of the pipeline.

In an embodiment, the plurality of sensors are composed of fiber optic cable wrapped around the pipeline. In some embodiments, the fiber optic cable wrapped around the pipeline includes a plurality of fiber optic sensing elements.

In an embodiment, the present invention is a system including a first fiber optic cable and a second fiber optic cable, each installed along a pipeline. The first fiber optic cable is connected to a plurality of sensors affixed to the pipeline, the first fiber optic cable providing communication between the plurality of sensors and a first interrogator. The second fiber optic cable is adapted to provide distributed fiber optic sensing along the length of the pipeline, passing signals through the second fiber optic cable to a second interrogator. The first and second interrogators provide for signal processing. The plurality of sensors may be fiber optic sensors, and may be composed of fiber optic cable wrapped around the pipeline. In some embodiments, the fiber optic sensors are affixed to the pipeline using a strip surrounding the circumference of the pipeline.

In another embodiment, the present invention is a system including a single fiber optic cable installed along the length of the pipeline, and adapted to provide distributed fiber optic sensing along the length of the pipeline.

The single fiber optic cable is in communication with a plurality of non-intrusive sensors positioned along the length of the pipeline. The plurality of non-intrusive sensors may be fiber optic sensors, and may be composed of fiber optic cable wrapped around the pipeline. In some embodiments, the fiber optic sensors are affixed to the pipeline using a strip surrounding the circumference of the pipeline. The single fiber optic cable is connected to an interrogator.

The present invention is also a method of detecting and locating leaks in a pipeline including installing a fiber optic cable along the length of a pipeline; installing a plurality of sensors along the length of the pipeline; and passing signals from the plurality of sensors through the fiber optic cable. In an embodiment, the fiber optic cable is also adapted to provide distributed fiber optic sensing along the length of the pipeline. In an embodiment, a plurality of local processors are positioned along the fiber optic cable and are associated with respective sensors of the plurality of sensors.

1This foregoing Section is intended to describe, with particularity, the preferred embodiments of the present invention. It is understood that modifications to these preferred embodiments can be made within the scope of the present claims. As such, this Section should not to be construed, in any way, as limiting of the broad scope of the present invention. The present invention should only be limited by the following claims and their legal equivalents.

### BRIEF DESCRIPTION OF DRAWINGS

FIG. 1A is a schematic view showing one configuration of the present invention wherein intrusive acoustic sensors are mounted along the pipeline for detection of acoustic waves (or negative pressure wave) within the pipe walls. Site processors are connected to local intrusive sensors and external fiber optic cables are used for communication between site and node processors. The outputs from the local acoustic sensor are processed and analyzed locally and the leak event signals from the local processors are transmitted through the fiber optic communication cable buried along the pipeline.

FIG. 1B is a schematic view showing another configuration of the present invention wherein intrusive acoustic sensors are mounted along the pipeline for detection of acoustic waves (or negative pressure wave) within the pipe walls. Site processors are connected to each local intrusive sensor and an external fiber optic cable is used for distributed fiber optic sensing for external leak detection. The outputs from the local acoustic sensor are processed and analyzed locally and the leak event signals from the local processors are transmitted through the fiber optic cable buried along the pipeline, along with the external leak detection signals.

FIG. 2 is a schematic view showing another configuration of the present invention wherein strain gauges type non-intrusive sensors are mounted directly on the outside wall of the pipe and strain gauges are utilized for measurement of acoustic (or negative pressure wave) signals generated within the pipeline. Site processors are connected to each local non-intrusive sensor and external fiber optic cables are used for communication between site and node processors. The outputs from the local acoustic sensor are processed and analyzed locally and the leak event signals from the local processors are transmitted through the fiber optic communication cable buried along the pipeline.

FIG. 2A is a schematic view showing another configuration of the present invention wherein non-intrusive sensors are mounted directly on the outside wall of the pipe and strain gauges are utilized for measurement of acoustic (or negative pressure wave) signals generated within the pipeline. Site processors are connected to each local non-intrusive sensor and an external fiber optic cable is used for both communication between site and node processors as well as for distributed fiber optic sensing of external leak signals. The outputs from the local acoustic sensor are processed and analyzed locally and the leak event signals from the local processors are transmitted through the fiber optic cable buried along the pipeline, along with the external leak detection signals.

FIG. 2B is a schematic view showing another configuration of the present invention wherein non-intrusive sensors are mounted directly on the outside wall of the pipe and fiber optic sensors are utilized for measurement of acoustic (or negative pressure wave) signals generated within the pipeline. Site processors are connected to each local non-intrusive sensor and an external fiber optic cable is used for communication between site and node processors. The outputs from the local fiber optic acoustic sensors are processed and analyzed locally by the local processors and the leak event signals from the local processors are transmitted through the communication fiber optic cable buried along the pipeline.

FIG. 2C is a schematic view showing another configuration of the present invention wherein non-intrusive sensors are mounted directly on the outside wall of the pipe and fiber optic sensors are utilized for measurement of acoustic (or negative pressure wave) signals generated within the pipeline. Site processors are connected to each local non-intrusive sensor and an external fiber optic cable is used for both communication between site and node processors as well as for distributed fiber optic sensing of external leak signals. The outputs from the local acoustic sensor are processed and analyzed locally and the leak event signals from the local processors are transmitted through the fiber optic cable buried along the pipeline, along with the external leak detection signals.

FIG. 2D is a schematic view showing another configuration of the present invention wherein non-intrusive sensors are mounted on the outside wall of the pipe through the use of the patented NIS metal mounting strip (Yang et al. 2013) wrapped around the entire circumference of the pipe wall and strain gauges are utilized for measurement of acoustic (or negative pressure wave) signals generated within the pipeline. Site processors are connected to each local non-intrusive sensor and an external fiber optic cable is used for communication between site and node processors. The outputs from the local acoustic sensor are processed and analyzed locally and the leak event signals from the local processors are transmitted through the fiber optic cable buried along the pipeline.

FIG. 2E is a schematic view showing another configuration of the present invention wherein strain gauges non-intrusive sensors are mounted on the outside wall of the pipe through the use of the patented NIS metal mounting strip (Yang et al. 2013) wrapped around the entire circumference of the pipe wall and strain gauges are utilized for measurement of acoustic (or negative pressure wave) signals generated within the pipeline. Site processors are connected to each local non-intrusive sensor and an external fiber optic cable is used for both communication between site and node processors as well as for distributed fiber optic sensing of external leak signals. The outputs from the local acoustic sensor are processed and analyzed locally and the leak event signals from the local processors are transmitted through the fiber optic cable buried along the pipeline, along with the external leak detection signals.

FIG. 2F is a schematic view showing another configuration of the present invention wherein fiber optic non-intrusive sensors are mounted on the outside wall of the pipe through the use of the patented NIS metal mounting strip (Yang et al. 2013) wrapped around the entire circumference of the pipe wall and strain gauges are substituted with fiber optic sensors for measurement of acoustic (or negative pressure wave) signals generated within the pipeline. Site processors are connected to each local non-intrusive sensor and an external fiber optic cable is used for communication between site and node processors. The outputs from the local acoustic sensor are processed and analyzed locally and the leak event signals from the local processors are transmitted through the fiber optic cable buried along the pipeline.

FIG. 2G is a schematic view showing another configuration of the present invention wherein non-intrusive sensors are mounted on the outside wall of the pipe through the use of the patented NIS metal mounting strip (Yang et al. 2013) wrapped around the entire circumference of the pipe wall and strain gauges are substituted with fiber optic sensors for measurement of acoustic (or negative pressure wave) signals generated within the pipeline. Site processors are connected to each local non-intrusive sensor and an external fiber optic cable is used for both communication between site and node processors as well as for distributed fiber optic sensing of external leak signals. The outputs from the local acoustic sensor are processed and analyzed locally and the leak event signals from the local processors are transmitted through the fiber optic cable buried along the pipeline, along with the external leak detection signals.

FIG. 2H is a schematic view showing another configuration of the present invention wherein a non-intrusive fiber optic sensor is mounted on the outside wall of the pipe by direct wrapping of the fiber optic sensing segment around the entire circumference of the pipe wall. The wrapped portion will have fiber optic sensors distributed along or at spaced intervals along the circumference of the pipe wall for measurement of acoustic (or negative pressure wave) signals generated within the pipeline. Site processors are connected to each local non-intrusive sensor and an external fiber optic cable is used for communication between site and node processors. The outputs from the local acoustic sensor are processed and analyzed locally and the leak event signals from the local processors are transmitted through the fiber optic cable buried along the pipeline.

FIG. 2I is a schematic view showing another configuration of the present invention wherein a non-intrusive fiber optic sensor is mounted on the outside wall of the pipe by applying direct wrapping of the fiber optic sensing segment around the entire circumference of the pipe wall. The wrapped portion will have fiber optic sensors distributed along or at spaced intervals along the circumference of the pipe wall for measurement of acoustic (or negative pressure wave) signals generated within the pipeline. Site processors are connected to each local non-intrusive sensor and an external fiber optic cable is used for both communication between site and node processors as well as for distributed fiber optic sensing of external leak signals. The outputs from the local acoustic sensor are processed and analyzed locally and the leak event signals from the local processors are transmitted through the fiber optic cable buried along the pipeline, along with the external leak detection signals.

FIG. 3A is a schematic view showing another alternative embodiment of the system of the present invention wherein two separate fiber optic cables are used. The first cable utilizes the non-intrusive sensor technology where quasi-distributed fiber optic sensors are directly installed on the outside wall of the pipeline for internal acoustic signal monitoring. The second cable utilizes distributed fiber optic sensing for external leak signal monitoring. There is no local site processor used in this system, and all signals are transmitted to the central processor for further analysis and leak detection.

FIG. 3B is a schematic view showing another alternative embodiment of the system of the present invention wherein two separate fiber optic cables are used. The first cable utilizes the non-intrusive sensor technology where quasi-distributed fiber optic sensors are installed on the outside wall of the pipeline through the use of the patented NIS metal mounting strip (Yang et al. 2013) wrapped around the entire circumference of the pipe wall for internal acoustic signal monitoring. The second cable utilizes distributed fiber optic sensing for external leak signal monitoring. There is no local site processor used in this system, and all signals are transmitted to the central processor for further analysis and leak detection.

FIG. 3C is a schematic view showing another alternative embodiment of the system of the present invention wherein two separate fiber optic cables are used. The first cable utilizes the non-intrusive sensor technology where the non-intrusive fiber optic sensing segments of the fiber optic cable is mounted on the outside wall of the pipe by applying the updated NIS patented technology [Yang et al. Provisional Patent] with direct wrapping of the fiber optic sensing segment around the entire circumference of the pipe wall at certain designated locations along the pipeline. The wrapped portion will have fiber optic sensors distributed along or at spaced intervals along the circumference of the pipe wall for internal acoustic signal monitoring. The second cable utilizes distributed fiber optic sensing for external leak signal monitoring. There is no local site processor used in this system, and all signals are transmitted to the central processor for further analysis and leak detection.

FIG. 3D is a detailed view showing the pipeline with a non-intrusive sensor installed, utilizing a fiber optic sensing element attached to the patented NIS mounting strip (Yang et al. 2013) to strap mount around the entire circumference of the pipeline for internal acoustic leak signal monitoring, as well as an externally installed fiber optic cable for external leak signal monitoring. There is no local site processor used in this system, and all signals are transmitted to the central processor for further analysis and leak detection. Updated NIS technology is applied with direct wrapping of the fiber optic sensing segment around the entire circumference of the pipe wall. The wrapped portion will have fiber optic sensing segments distributed along or at spaced intervals along the circumference of the pipe wall for internal acoustic signal monitoring. An externally installed fiber optic cable for external leak signal monitoring is also shown. There is no local site processor used in this system, and all signals are transmitted to the central processor for further analysis and leak detection.

FIG. 3E is a detailed view showing the pipeline with a non-intrusive sensor installed, utilizing a fiber optic sensing loop wrapped around the circumference of the pipeline for internal acoustic leak signal monitoring, as well as an externally installed fiber optic cable for external leak signal monitoring.

FIG. 4A is a schematic view showing another alternative embodiment of the system of the present invention wherein a single fiber optic cable is used for both quasi-distributed internal acoustic leak signal monitoring, with certain segments of the fiber optic cable used as the sensing element directly installed on the outside wall of the pipeline, and other segments are used for distributed fiber optic sensing for external leak signal monitoring. There is no local site processor used in this system, and all signals are transmitted to the central processor for further analysis and leak detection.

FIG. 4B is a schematic view showing another alternative embodiment of the system of the present invention wherein a single fiber optic cable is used for both quasi-distributed internal acoustic leak signal monitoring, with certain segments of the fiber optic cable used as a sensing element attached to the patented NIS metal mounting strip (Yang et al. 2013) wrapped around the entire circumference of the pipeline, and other segments are used for distributed fiber optic sensing for external leak signal monitoring. There is no local site processor used in this system, and all signals are transmitted to the central processor for further analysis and leak detection.

FIG. 4C is a schematic view showing another alternative embodiment of the system of the present invention wherein a single fiber optic cable is used for both quasi-distributed internal acoustic leak signal monitoring, with certain segments of the fiber optic cable used as non-intrusive sensing elements, which are mounted on the outside wall of the pipe by applying updated NIS technology with direct wrapping of the fiber optic sensing segment around the entire circumference of the pipe wall at certain designated locations along the pipeline. The other segments of the cable are used for distributed fiber optic sensing for external leak signal monitoring. The wrapped portion will have fiber optic sensors distributed along or at spaced intervals along the circumference of the pipe wall for internal acoustic signal monitoring. There is no local site processor used in this system, and all signals are transmitted to the central processor for further analysis and leak detection.

### DETAILED DESCRIPTION OF THE INVENTION

In a pipe, pipeline, flow channel of any kind, or most of pressurized enclosed systems, pressure is usually stable and different (either greater or lower than) from the outside environment in order to facilitate transporting of fluid from one end to another. When a leak does occur the pressure boundary is broken down and the inside pressure will go through a rapid transient in reaching for a new equivalent point with the presence of surrounding ambient pressure. This causes the fluid to escape (or inject in case of the inside pressure being lower than the outside pressure such as condenser tubes) rapidly at the point of the leak, causing pressure to drop significantly in that area, which also causes the direction of flow to change instantly (or temporarily) in the area directly related to the leak, as the surrounding fluid would flow toward the local lowest pressure point, the leak point. Utilizing non-intrusive fiber optics throughout the length of the pipeline to replace conventional strain gauge type non-intrusive sensors would increase sensitivity of detecting acoustic signals propagated inside the pipeline. This would drastically affect the ability of the acoustic sensors to pick up the signal or negative pressure wave generated by the leak.

For the internal leak detection, different embodiments of this apparatus provide that individual fiber optic sensor can be used as a direct replacement of the conventional strain gauge as an Non-Intrusive sensor (NIS) for acoustic wave (or negative pressure wave) detection using either as a part sensing element for local processor (site processor) to detect the occurrence of leak or as a part of sensing elements in the centralized data processing and leak detection systems as described in this invention. In this central leak detection approach, for the internal leak detection, the sensing segment of the fiber optic cable at various intervals along the pipeline can be either directly installed on the outside wall of the pipeline, or installed via attachment to the patented NIS metal mounting strip (Yang et al. 2013) wrapped around the entire circumference of the pipe wall, or by applying updated NIS technology with direct wrapping of the fiber optic sensing segment around the entire circumference of the pipe wall. Ideally, the cable would be secured at a distance that would allow the signature leak generated acoustic signals (or negative/positive pressure waves in case of inside lower pressure than outside of the pipeline) to be acquired, and the resulting strain changes on the pipe wall in the areas can be detected by the fiber optic sensing segment (or fiber optic sensor). In this way, the fiber optic cable would be able to detect the unique acoustic wave or negative pressure wave by continuously sending the strain signals with unique changing pattern resembling the passing of unique leak generated acoustic pressure wave (or negative pressure wave) that propagate along the pipeline. All the signals, including the ones associated with unique leak generated acoustic wave, will be transmitted and gathered at the central processor unit to be analysis for leak detection and leak location determination.

For the external leak detection, another different embodiment of this invention, a fiber optic cable(s) (either a general communication cable or a dedicated leak detection cable) are installed along the length of the pipeline in proximity as described above (usually about half meter or more away or right next to the pipeline), and they act as a continuous, distributed sensor, or distributed fiber optic sensing (DFOS), with intent to monitor the entire length of the pipeline in real-time basis and detect leak by detecting any change of properties (such as changes of temperature, vibration, or strain) or any phenomena (vibration or noise) caused by the leaking event at any vicinity of the sensing cable through the external impact of the discharged fluid, with detecting span at the distance of sensing resolution.

In the invention, the above two approaches, internal and external leak detections, can be applied separately or in together to provide redundant leak detection.

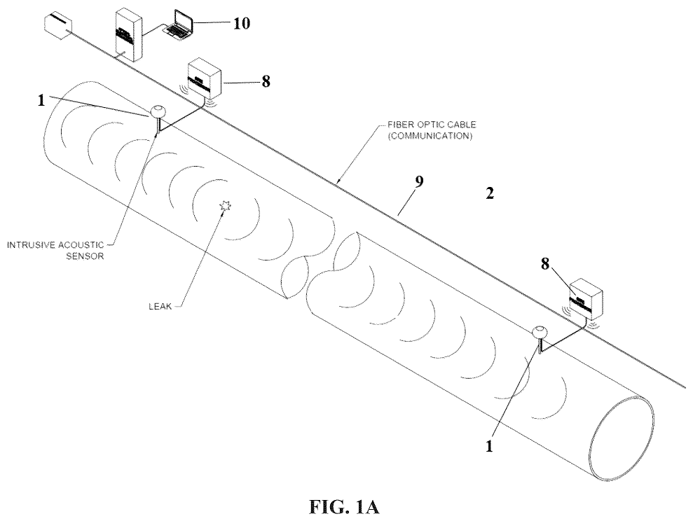

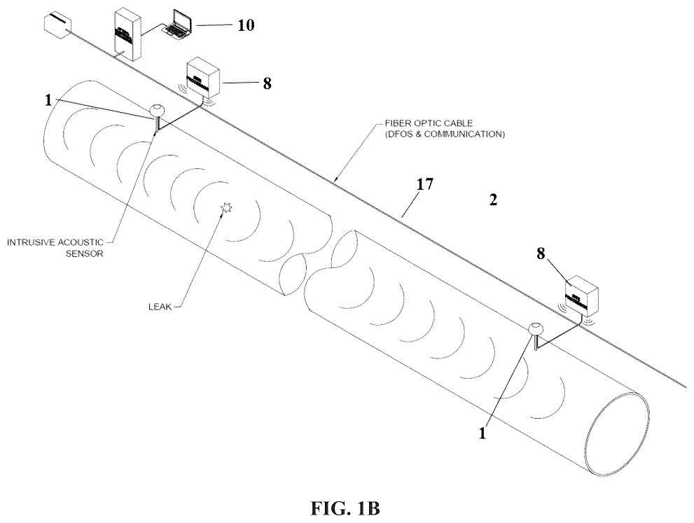

Referring to FIG. 1A, one configuration of the system 2 of the present invention is shown. In this arrangement, intrusive acoustic sensors 1 detect signals generated by a leak in the pipeline. Acoustic signals are processed using advanced filtering techniques described in the inventor's previous patents. Directional filtering and signal processing is done via a connection to local site processors 8 installed at each intrusive sensor location. A fiber optic cable 9 installed along the length of the pipeline in proximity is used for communication between site processors and external node processors 10. An optical electrical converter is also required for signal processing prior to the central PC/node processor. Additionally, based on the arrival time of the acoustic signal at each of the sensor locations, the location of the leak can be determined through the use of time of flight-based calculation principles.

Referring to FIG. 1B, one configuration of the system 2 of the present invention is shown. In this arrangement, intrusive acoustic sensors 1 detect signals generated by a leak in the pipeline. Acoustic signals are processed using advanced filtering techniques described in the inventor's previous patents. Directional filtering and signal processing is done via a connection to local site processors 8 installed at each intrusive sensor location. A fiber optic cable 9 installed along the length of the pipeline in proximity is used for communication between site processors and external node processors 10 as well as for distributed fiber optic sensing of external leak signals. An optical electrical converter is also required for signal processing prior to the central PC/node processor. Additionally, based on the arrival time of the acoustic signal at each of the sensor locations, the location of the leak can be determined through the use of time of flight-based calculation principles.

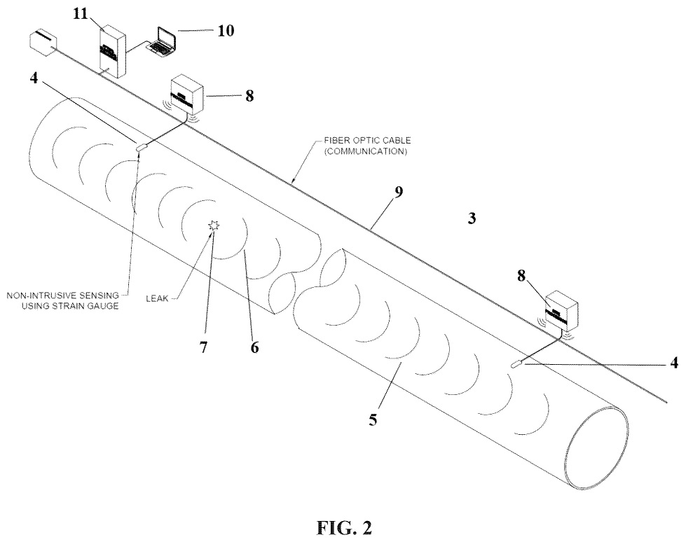

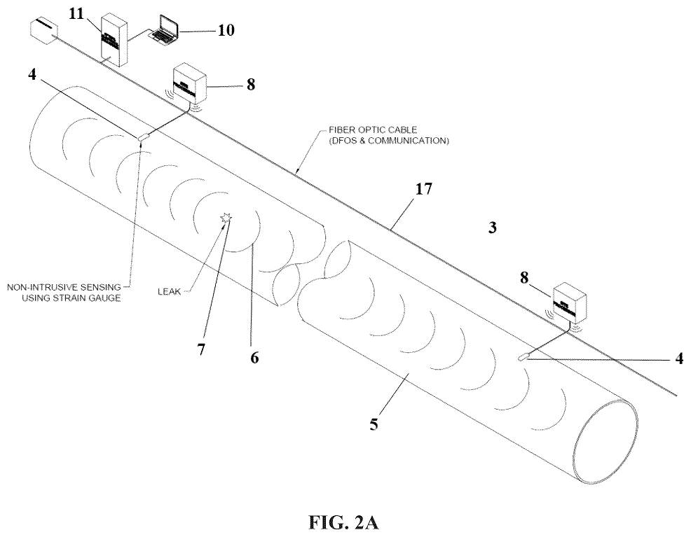

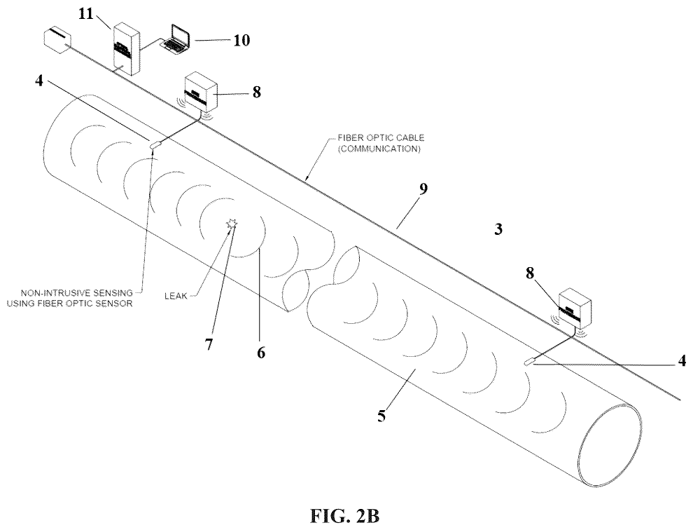

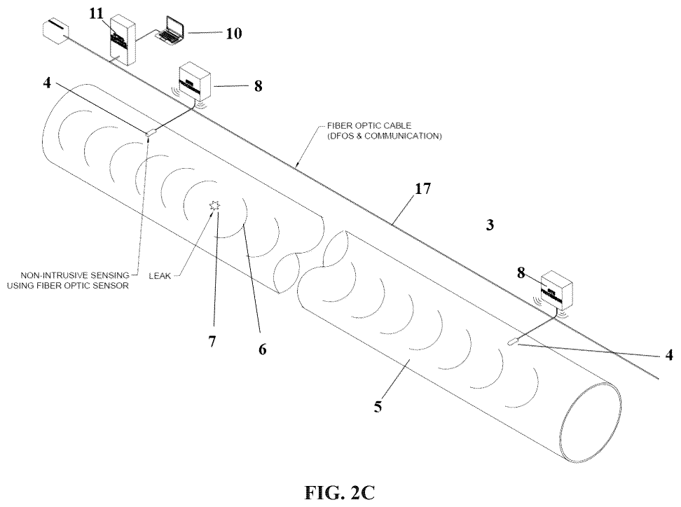

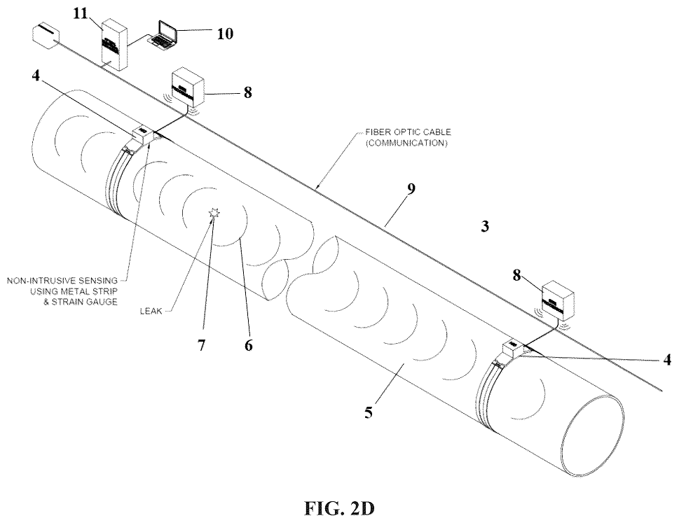

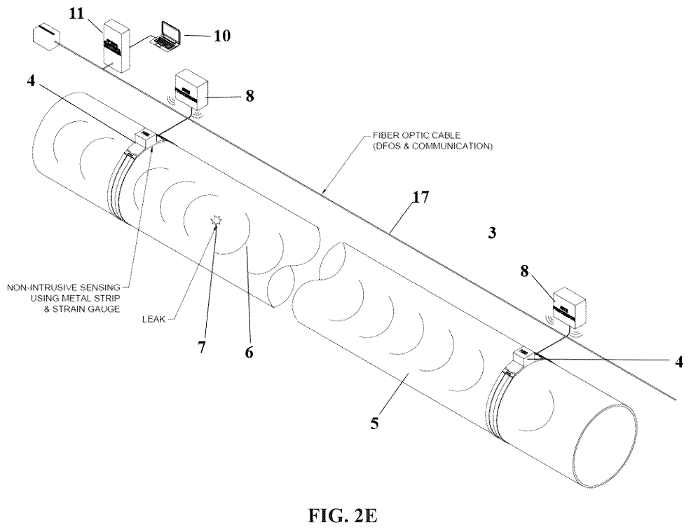

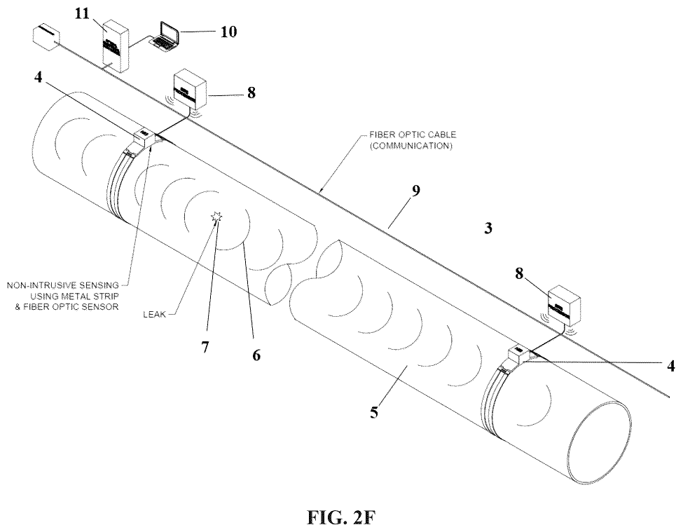

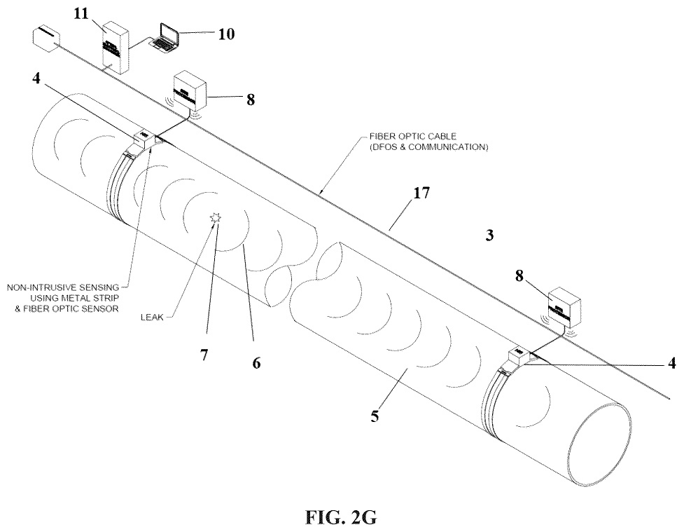

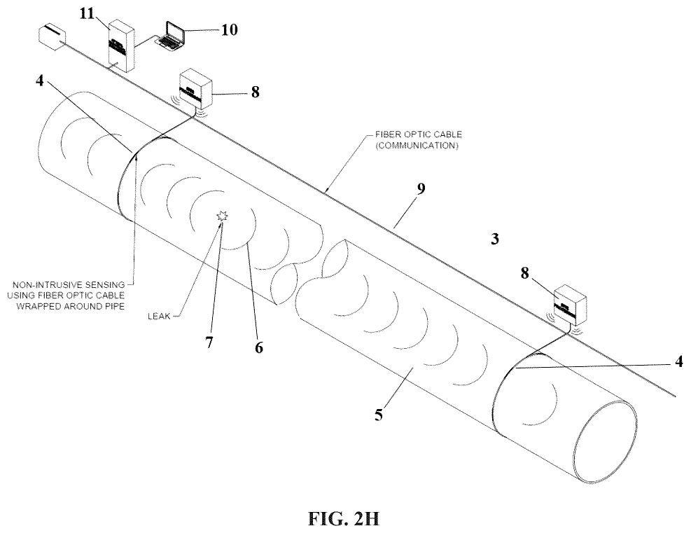

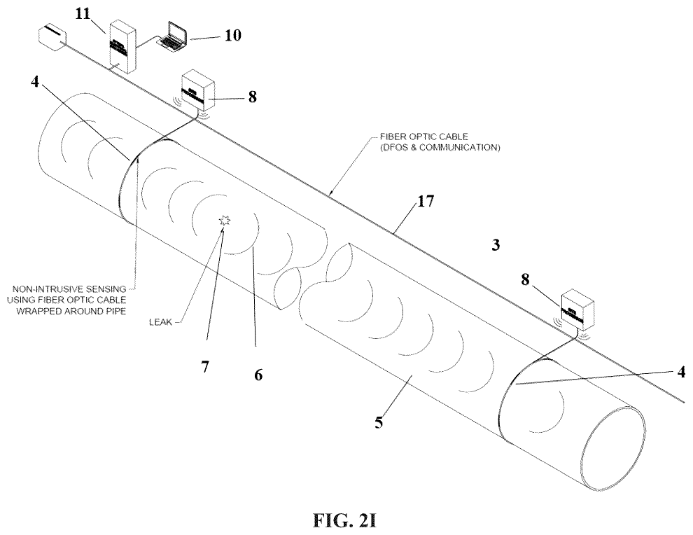

Referring to FIG. 2, one configuration of the system 3 of the present invention is shown. Each of the non-intrusive sensors 4 shown in FIG. 2 and subsequent figures represent an array of sensors in spaced relation along the length of the pipeline 5. In this arrangement, strain gauges measure acoustic signals 6 generated by a leak 7 in the pipeline. Acoustic signals are similarly processed using advanced filtering techniques described in the inventor's previous patents. Directional filtering and signal processing is done via a connection to local site processors 8 installed at each non-intrusive sensor location. A fiber optic cable 9 installed along the length of the pipeline in proximity is used for communication between site processors and external node processors 10. An optical electrical converter 11 is also required for signal processing prior to the central PC/node processor. Additionally, based on the arrival time of the acoustic signal at each of the sensor locations, the location of the leak can be determined through the use of time of flight-based calculation principles.

Referring to FIG. 2A, the same configuration of the system 3 of the present invention is shown. However, in this figure local site processors communicate to the central PC or node processor via a fiber optic cable 17 that is also used for distributed fiber optic sensing of external leak signals.

Referring to FIG. 2B, one configuration of the system 3 of the present invention is shown. Each of the non-intrusive sensors 4 shown in FIG. 1 and subsequent figures represent an array of sensors in spaced relation along the length of the pipeline 5. In this arrangement, fiber optic sensors measure acoustic signals 6 generated by a leak 7 in the pipeline. Acoustic signals are similarly processed using advanced filtering techniques described in the inventor's previous patents. Directional filtering and signal processing are done via a connection to local site processors 8 installed at each non-intrusive sensor location. A fiber optic cable 9 installed along the length of the pipeline in proximity is used for communication between site processors and central node processors 10. An optical electrical converter 11 is also required for signal processing prior to the central PC/node processor. Additionally, based on the arrival time of the acoustic signal at each of the sensor locations, the location of the leak can be determined through the use of time of flight-based calculation principles.

Referring to FIG. 2C, the same configuration of the system 3 of the present invention is shown. However, in this figure local site processors communicate to the central PC or node processor via a fiber optic cable 17 that is also used for distributed fiber optic sensing of external leak signals.

Referring to FIG. 2D, one configuration of the system 3 of the present invention is shown. Each of the non-intrusive sensors 4 shown in FIG. 1 and subsequent figures represent an array of sensors in spaced relation along the length of the pipeline 5. In this arrangement, strain gauges measure acoustic signals 6 generated by a leak 7 in the pipeline. Acoustic signals are similarly processed using advanced filtering techniques described in the inventor's previous patents. Directional filtering and signal processing are done via a connection to local site processors 8 installed at each non-intrusive sensor location. A fiber optic cable 9 installed along the length of the pipeline in proximity is used for communication between site processors and central node processors 10. An optical electrical converter 11 is also required for signal processing prior to the central PC/node processor. Additionally, based on the arrival time of the acoustic signal at each of the sensor locations, the location of the leak can be determined through the use of time of flight-based calculation principles.

Referring to FIG. 2E, the same configuration of the system 3 of the present invention is shown. However, in this figure local site processors communicate to the central PC or node processor via a fiber optic cable 17 that is also used for distributed fiber optic sensing of external leak signals.

Referring to FIG. 2F, another configuration of the system 3 of the present invention is shown. Non-intrusive sensors 4 are similarly used along the pipeline 5 at spaced relations. The non-intrusive sensors in this configuration utilize fiber optic sensing elements attached to the patented NIS metal strip that wraps around the circumference of the pipe for strain measurement. The fiber optic sensors provide increased sensitivity with installations of the fiber optic sensors on the outside wall of the pipeline in place of conventional strain gauge as described in the previous patented technology by the first-named inventor (Yang et al. 2013). Based on this patented technology, such installation will allow for further amplification of the signal and increased sensitivity of detecting the changes of strain on the pipe wall. The implementation of fiber optic sensors for non-intrusive acoustic leak detection applications was described in the inventor's previous patent (Yang et al. 2023).

Referring to FIG. 2G, the same configuration of the system 3 of the present invention is shown. However, in this figure local site processors communicate to the central PC or node processor via a fiber optic cable 17 that is also used for distributed fiber optic sensing of external leak signals.

Referring to FIG. 2H, another configuration of the system 3 of the present invention is shown. Non-intrusive sensors 4 are similarly used along the pipeline 5 at spaced relations. The non-intrusive sensors in this configuration utilize specially designed fiber optic sensing segments and the optic cables wrapped around the circumference of the pipe with sensing elements at spaced intervals. Such installation will allow for increased sensitivity of detecting the changes of strain on the pipe wall.

Referring to FIG. 2I, the same configuration of system 3 of the present invention is shown. However, in this figure local site processors communicate to the central PC or node processor via a fiber optic cable 17 that is also used for distributed fiber optic sensing of external leak signals.

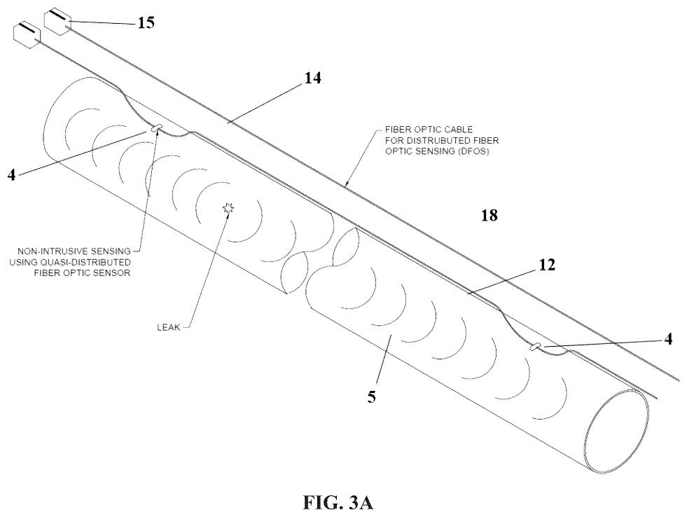

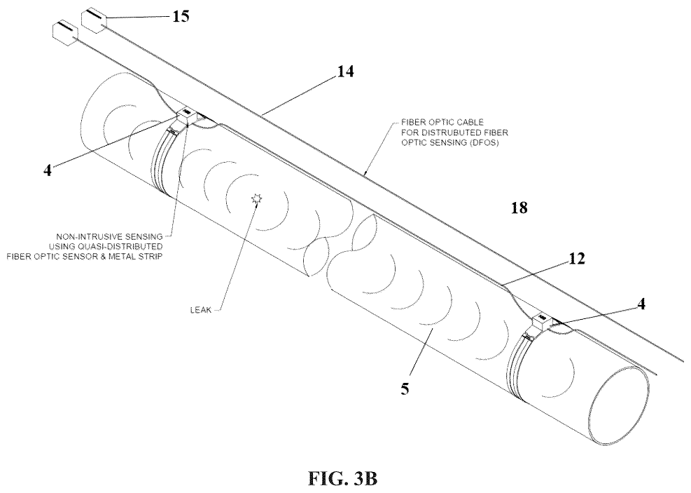

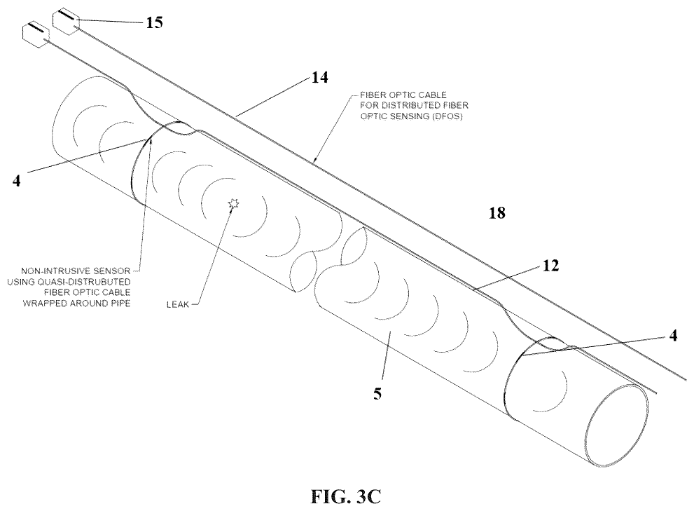

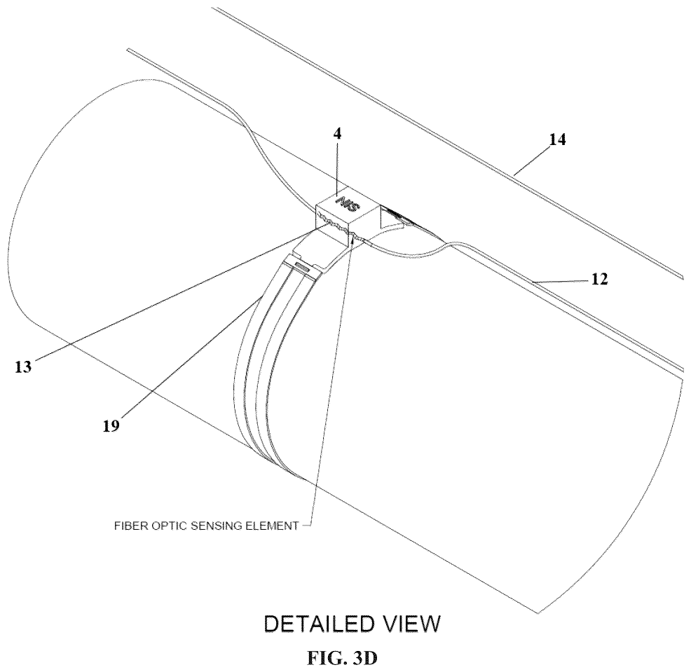

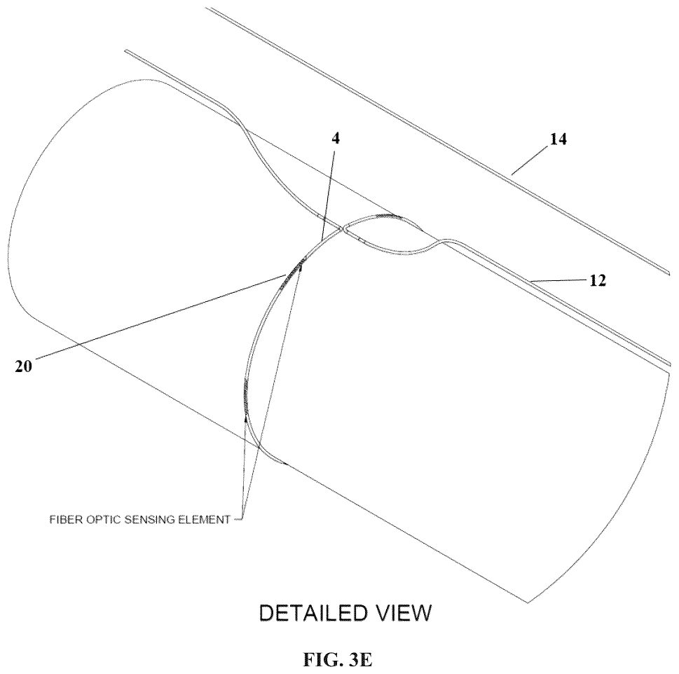

Referring to FIGS. 3A, 3B and 3C, one configuration of the system 18 of the present invention is shown. In this configuration, quasi-distributed fiber optic sensing is used along a fiber optic cable 12. At each non-intrusive sensor location, the cable 12 is looped down from the typical proximity installation location, where it is then attached to the surface of the pipe either directly (as shown in FIG. 3A), through attachment to the patented NIS metal strip (as shown in FIG. 3B), or via applying a fiber optic sensing loop to wrap the fiber optic sensors around the circumference of the pipe (as shown in FIG. 3C). This fiber optic sensing segment allows for measurement of the internal acoustic signals traveling along the inside of the pipe. The sensing element may utilize Fiber Bragg Grating (FBG) or other quasi-distributed fiber optic sensing technology. A second fiber optic cable 14 for dedicated distributed fiber optic sensing is used for the detection of external leak signals allowing for dual sensing based on either optical time domain reflection (OTDR) or on optical frequency domain reflection (OFDR). This configuration eliminates the need for local site processors as the fiber optic cable itself will transfer the light characteristics to an off-site interrogator 15 at a central location for signal processing. No local site processors are required for this configuration as both the quasi-distributed and distributed fiber optic sensing elements connect to an off-site interrogator 15 at a central location for signal processing.

Referring to FIG. 3D, a detailed view of the patented NIS metal strip (Yang et al. 2013) wrapped around the circumference of the pipeline is shown. The non-intrusive sensor 4 uses a fiber optic sensing element 13 attached to the patented metal strip 19 that wraps around the pipeline. When a leak occurs, the acoustic wave (or negative pressure wave) generated by the leak event at leak location propagate outward and the internal acoustic wave travelling along the pipeline causing a wave of changes on the strain of the wall along the pipeline, which is to be detected at the location of the sensor to allow for measurement of traveling acoustic pressure wave (or negative pressure wave). The use of patented metal strip (Yang et al. 2013) or fiber optic sensing loop allows for the accumulation of all the strains along the entire circumference, which can increase S/N ratio and boost the sensitivity significantly. A second fiber optic cable for dedicated distributed fiber optic sensing 14 is used for detection of external leak signals allowing for dual internal and external leak detection.

Referring to FIG. 3E, a detailed view of the NIS utilizing a fiber optic sensing loop (or cable) 20 wrapped around the circumference of the pipeline is shown. The non-intrusive sensor 4 uses fiber optic sensing elements (spaced about sensing loop 20) along the portion of the wire wrapped around the pipeline, at spaced intervals. These sensing elements may include, but are not limited to, Fiber Bragg Gratings (FBG) with pre-inscribed special pattern of material interferences, or any other type of quasi-distributed fiber optic sensing element. This configuration allows for direct measurement of the internal acoustic signals traveling along the inside of the pipe or strain changes in the pipe wall circumference. A second fiber optic cable 14 for dedicated distributed fiber optic sensing is used for detection of external leak signals allowing for dual internal and external leak detection.

The use of the fiber optic sensing loop 20 allows for strain measurement at multiple points along the circumference of the pipe, significantly improving sensitivity and reliability compared to the traditional design that only measures accumulated strain at one point. The sensing elements may also be utilized at a plurality of locations along the entire length of the cable, allowing for measurement of strain changes and other internal leak generated signals at multiple points along the pipeline. This is achieved through control of incident light characteristics, pulse frequencies, and operating wavelengths of the individual sensing elements. Replacing the traditional NIS technology with this loop-type design increases reliability, improves efficiency, reduces false alarms, and boosts the overall system performance.

It is within the concept of the present invention that a distributed fiber optic sensing cable can be used in place of the quasi-distributed sensors in the fiber optic sensing loop. The distributed cable can be used to measure any leak induced signals, including strain, temperature, vibration and acoustic. The signal is processed using algorithms that may be, but are not limited to, Rayleigh Scattering DAS (Distributed Acoustic Sensing), Brillouin Scattering (Distributed Strain Sensing (DSS/DTS or DTSS)), Raman Scattering (DTS), or other scattering techniques to detect the leak generated signals that travel inside the pipeline or are transmitted through the pipe wall. In this case, the entire portion of the cable looped around the pipe is acting as the sensing element, allowing for measurement of any leak induced signals around the full circumference of the pipe.

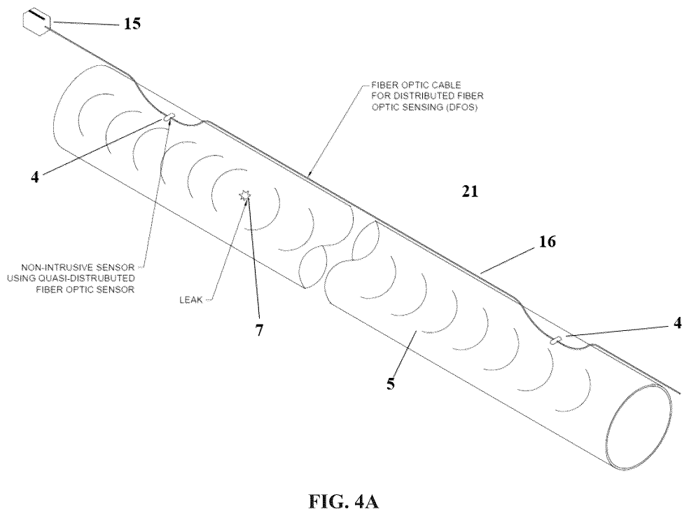

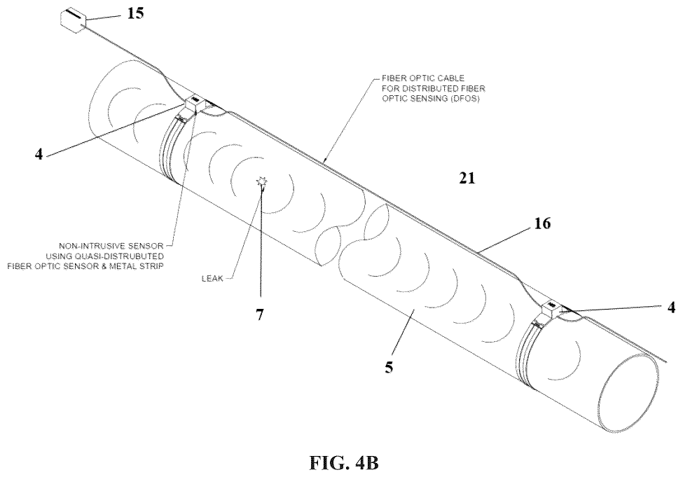

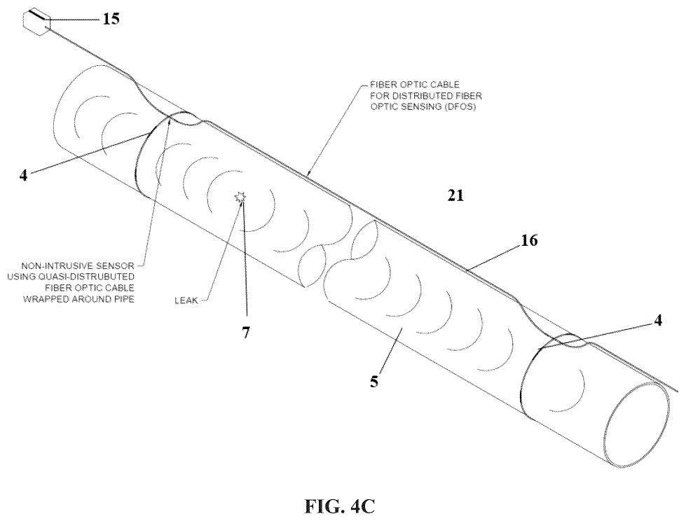

Referring to FIG. 4A, another configuration of system 21 of the present invention is shown. In this configuration, a single fiber optic cable is used for both internal and external leak signal monitoring 16. Distributed fiber optic sensing is achieved along the length of the pipeline 5 as the cable is installed in close proximity to the pipeline to capture external signals or physical changes caused by the leak 7. Simultaneously, internal acoustic leak signal detection is achieved through direct installation of non-intrusive sensors 4 at spaced intervals on the pipeline. No local site processors are required for this configuration as both the quasi-distributed and distributed fiber optic sensing elements connect to an off-site interrogator at a central location 15 for signal processing.

Referring to FIG. 4B, another configuration of system 21 of the present invention is shown. In this configuration, a single fiber optic cable 16 is used for both internal and external leak signal monitoring. Distributed fiber optic sensing is achieved along the length of the pipeline 5 as the cable 16 is installed in close proximity to the pipeline to capture external signals or physical changes caused by the leak 7. Simultaneously, internal acoustic leak signal detection is achieved through installation of non-intrusive sensors 4 at spaced intervals on the pipeline attached to the patented NIS metal strip (Yang et al. 2013) that wraps around the circumference of the pipeline. No local site processors are required for this configuration as both the quasi-distributed and distributed fiber optic sensing elements connect to an off-site interrogator at a central location 15 for signal processing.

Referring to FIG. 4C, another configuration of system 21 of the present invention is shown. In this configuration, a single fiber optic cable 16 is used for both internal and external leak signal monitoring. Distributed fiber optic sensing is achieved along the length of the pipeline 5 as the cable is installed in close proximity to the pipeline to capture external signals or physical changes caused by the leak 7. Simultaneously, internal acoustic leak signal detection is achieved through installation of non-intrusive sensors 4 at spaced intervals on the pipeline via fiber optic cables wrapped around the circumference of the pipeline. The sensing elements may be either fully along the wrapped section of the fiber optic sensing loop or at spaced intervals around the circumference of the pipe. No local site processors are required for this configuration as both the quasi-distributed and distributed fiber optic sensing elements connect to an off-site interrogator at a central location 15 for signal processing.

1. A system for detecting and locating leaks in a pipeline, the system comprising:
a plurality of sensors positioned at spaced intervals along the pipeline, wherein the plurality of sensors are adapted to measure internal leak signals;
at least one fiber optic cable installed externally to the pipeline for measurement of internal leak signals and/or external leak signals, the at least one fiber optic cable being in communication with the plurality of sensors; and
at least one signal processor programmed and adapted to process analyzed data gathered via the plurality of sensors and communicated via the at least one fiber optic cable.

2. The system of claim 1, said plurality of sensors comprising non-intrusive fiber optic sensors.

3. The system of claim 2, wherein said non-intrusive fiber optic sensors comprise quasi-distributed fiber optic sensors.

4. The system of claim 3, wherein each of the quasi-distributed fiber optic sensors are attached to the pipeline using a metal strip.

5. The system of claim 3, wherein the quasi-distributed fiber optic sensors comprise quasi-distributed fiber optic cable wrapped around the pipeline.

6. The system of claim 1, wherein the internal leak signals comprise negative or positive acoustic pressure waves, strain, and vibration leak signals.

7. The system of claim 1, wherein the at least one fiber optic cable is adapted for distributed fiber optic sensing along the pipeline.

8. The system of claim 1, said at least one signal processor comprising an interrogator in communication with the at least one fiber optic cable.

9. The system of claim 1, further comprising:
a leak computer comprising effective computing, storage, display, and other necessary functions to provide further advanced data processing, leak location calculation or verification, data and history recording, and human machine interfacing.

10. The system of claim 1, the at least one fiber optic cable comprising:
a first fiber optic cable being connected to the plurality of sensors; and
a second fiber optic cable installed externally to the pipeline, the second fiber optic cable adapted for distributed fiber optic sensing along the pipeline.

11. A system comprising:
a plurality of sensors positioned along a pipeline;
at least one fiber optic cable installed along the pipeline, the plurality of sensors being in communication with the at least one fiber optic cable;
a plurality of local processors in communication with respective sensors of the plurality of sensors, wherein the at least one fiber optic cable is adapted to provide communication between the plurality of local processors and a node processor.

12. The system of claim 11, wherein the plurality of sensors are intrusive acoustic sensors.

13. The system of claim 11, wherein the plurality of sensors are non-intrusive strain gauge acoustic sensors.

14. The system of claim 11, wherein the plurality of sensors are fiber optic sensors.

15. The system of claim 11, wherein the at least one fiber optic cable is adapted to provide both communication between the plurality of local processors and the node processor and also distributed fiber optic sensing along the length of the at least one fiber optic cable.

16. The system of claim 11, wherein each of the fiber optic sensors are attached to the pipeline using a metal strip.

17. The system of claim 11, wherein the fiber optic sensors comprise quasi-distributed fiber optic cable wrapped around the pipeline.

18. A method of detecting and locating leaks in a pipeline comprising:
installing a fiber optic cable along a length of the pipeline;
installing a plurality of sensors along the length of the pipeline; and
passing signals from the plurality of sensors through the fiber optic cable to a signal processor.

19. The method of claim 18, the fiber optic cable is also adapted to provide distributed fiber optic sensing along the length of the pipeline.

20. The method of claim 19, wherein a plurality of local processors are positioned along the fiber optic cable and are associated with respective sensors of the plurality of sensors.
